(19) United States
(12) Patent Application Publication
(10) Pub. No.: US 2026/0326619 A1
(43) Pub. Date: Oct. 22, 2026

(54) METHOD FOR CONTROLLING HYDROGEN ELECTRIC VEHICLE EQUIPPED WITH HYDROGEN STORAGE SYSTEM AND FUEL CELL SYSTEM AND APPARATUS THEREFOR

(71) Applicants: HYUNDAI MOTOR COMPANY, SEOUL (KR); KIA CORPORATION, SEOUL (KR)

(72) Inventors: Se Kwon Jung, Hwaseong-si (KR); Jun Sung Ahn, Hwaseong-si (KR); Sang Moo Han, Hwaseong-si (KR)

(73) Assignees: HYUNDAI MOTOR COMPANY, SEOUL (KR); KIA CORPORATION, SEOUL (KR)

(21) Appl. No.: 19/356,815

(22) Filed: Oct. 13, 2025

(30) Foreign Application Priority Data
Apr. 17, 2025 (KR) 10-2025-0050386

(51) Int. Cl. B60L 58/40; B60L 50/60; B60L 58/12; B60L 58/30; H01M 8/04302; H01M 8/0438; H01M 10/44; H01M 16/00

(52) U.S. Cl. CPC B60L 58/40; B60L 50/60; B60L 58/12; B60L 58/30; H01M 8/04302; H01M 8/04388; H01M 10/44; H01M 16/006; H01M 2220/20; H01M 2250/20; H01M 2250/402

(57) ABSTRACT

Disclosed are a method of controlling a hydrogen electric vehicle and an apparatus therefor. The hydrogen electric vehicle is equipped with a hydrogen storage system and a fuel cell system. The method includes charging a battery by consuming a hydrogen fuel through an operation of the fuel cell system based on an ignition off command for the vehicle being input, and controlling an ignition off of the vehicle based on the charging of the battery being completed.

### CROSS-REFERENCE TO RELATED APPLICATION(S)

This application claims the benefit of priority to Korean Patent Application No. 10-2025-0050386, filed in the Korean Intellectual Property Office on Apr. 17, 2025, the entire contents of which are incorporated herein by reference.

### TECHNICAL FIELD

The present disclosure relates to a hydrogen electric vehicle, and more particularly, relates to a technology for minimizing fuel loss due to evaporative hydrogen emission by maximizing a hold time of a cryogenic hydrogen storage system.

### BACKGROUND

Carbon neutrality is currently a popular topic worldwide.

Major economic countries are seeking ways to expand power production using renewable energy instead of traditional fossil fuels.

A green energy system is a system that uses energy obtained through renewable energy such as wind, hydro, tidal, and solar power as electric energy and hydrogen energy.

Among them, green hydrogen is evaluated as a useful eco-friendly energy since it does not emit greenhouse gases during the production process, and hydrogen, which is emerging as an alternative energy source on a global scale, is classified into gray hydrogen, blue hydrogen, and green hydrogen depending on the production method.

Recently, as electric vehicles have become more popular, research on electric vehicles equipped with eco-friendly hydrogen fuel cells is actively being conducted.

Hydrogen-based electric vehicles provide fast charging times and long driving distances with one hydrogen charge due to their high energy density compared to electric vehicles based on general high-voltage batteries.

Liquid hydrogen storage tanks store liquid hydrogen at a temperature of approximately 20K to 33K. To store liquid hydrogen for a long period of time, liquid hydrogen storage tanks use vacuum insulation to secure a high level of insulation performance, but due to physical/structural limitations, the liquid hydrogen storage tanks may not completely block external heat inflow. In addition, the latent heat and specific heat of liquid hydrogen are small compared to other substances. Liquid hydrogen may evaporate and expand quickly, and the density of liquid hydrogen also may decrease with increasing temperature, so the pressure inside the container may increase. When the pressure inside the container increases beyond the allowable pressure due to evaporation and expansion of liquid hydrogen, the container may be damaged or ruptured, so a boil-off valve and a pressure relief valve are provided to prevent damage to the container by discharging the hydrogen from the inside to the outside when the pressure inside the container exceeds a certain level. In this embodiment, since the hydrogen inside is discharged to the outside, hydrogen, which is the fuel for the vehicle, is lost, and when (e.g., excessive) hydrogen is discharged to the outside without a post-processor installed, the risk of fire may increase.

Therefore, improving fuel efficiency and safety by maximizing the hold time during which liquid hydrogen in a liquid hydrogen storage system is held within the storage system (e.g., is not released to the outside) may be useful.

### SUMMARY

The present disclosure has been made to address the above-mentioned challenges.

The present disclosure provides a control method for increasing a hold time of a hydrogen storage system in a hydrogen electric vehicle and an apparatus therefor.

The present disclosure provides a hydrogen electric vehicle control method and an apparatus therefor capable of minimizing fuel loss due to evaporative hydrogen emission by (e.g., maximally) increasing a hold time (or a holding time or a dormancy) of a liquid hydrogen storage system.

The present disclosure provides a fuel cell system battery control method and an apparatus therefor capable of maximizing a hold time by variably controlling a wake-up time according to a pressure and an SOF (State of Fuel) of a liquid hydrogen storage system and minimizing fuel loss due to evaporation of hydrogen under long-term parking conditions of a hydrogen fuel cell vehicle.

The present disclosure provides a hydrogen electric vehicle control method and an apparatus therefor, which may minimize fuel loss and prevent the risk of fire by supplying gaseous hydrogen to a fuel cell system to drive a stack instead of discharging hydrogen through a boil-off valve when liquid hydrogen evaporates and expands due to external heat inflow into a liquid hydrogen container and the pressure inside the container increases, thereby generating electricity without discharging hydrogen to the outside and charging a battery.

The present disclosure is not limited to the aforementioned challenges, and any other challenges not mentioned herein may be understood from the description herein.

According to the present disclosure, a method of controlling a hydrogen electric vehicle equipped with a hydrogen storage system and a fuel cell system is provided. The method includes charging a battery by consuming a hydrogen fuel through an operation of the fuel cell system, based on an ignition off command for the vehicle being input, and controlling an ignition off of the vehicle based on the charging of the battery being completed.

According to an example embodiment, the method may further include determining whether a long-term parking is planned after arriving at a preset destination, and controlling an SOC ratio while the vehicle is operating such that the SOC ratio is lower than a specified (e.g., predetermined) SOC reference ratio upon arrival at the destination when long-term parking is planned.

According to an example embodiment, the method may further include measuring an internal pressure of a hydrogen storage tank based on the ignition off command for the vehicle being input, and the fuel cell system may be operated based on the measured internal pressure being greater than or equal to a preset reference pressure.

According to an example embodiment, the method may further include comparing an SOF (State Of Fuel) ratio of the hydrogen storage tank with a specified SOF reference ratio based on the measured internal pressure being less than the preset reference pressure, waiting for a preset period of time after the ignition off of the vehicle based on the comparison result, and waking up a controller after the waiting for the preset period of time, and the fuel cell system may be operated by the woken-up controller.

According to an example embodiment, the method may further include waiting for a first time after the ignition off of the vehicle based on the SOF ratio being greater than or equal to the SOF reference ratio, and waiting for a second time after the ignition off of the vehicle based on the SOF ratio being less than the SOF reference ratio, and the first time may be set to be longer than the second time, and the first time may be set to an arbitrary value within 48 hours.

According to an example embodiment, the method may further include monitoring a change in the internal pressure of the hydrogen storage tank for the second time based on the SOF ratio being less than the SOF reference ratio, and the controller may be woken up at a time before the internal pressure reaches a preset BOV (Boil-Off Valve) operating pressure. In this embodiment, the preset BOV operating pressure may be a pressure at which a BOV opens and hydrogen begins to escape, and may be defined as a BOV set pressure or a BOV cracking pressure.

According to an example embodiment, based on the measured internal pressure being less than the preset reference pressure and the SOF ratio being greater than or equal to the SOF reference ratio, an output of the fuel cell system may be operated with an output limited to a preset ratio of a maximum output or less.

According to an example embodiment, based on the measured internal pressure being less than the preset reference pressure and the SOF ratio being less than the SOF reference ratio, an output of the fuel cell system may be operated at a maximum output.

According to an example embodiment, the SOF reference ratio may be set to any value less than 30% or 40%.

According to an example embodiment, the SOC reference ratio may be set to an arbitrary value of 40% or less based on at least one of a normal operating condition of the vehicle and/or an allowable life condition of the battery.

According to the present disclosure, a computing apparatus of controlling a hydrogen electric vehicle equipped with a hydrogen storage system and a fuel cell system is provided. The computing apparatus includes a processor that executes commands, and a memory that stores (e.g., and accesses) the commands. The processor may charge a battery by consuming a hydrogen fuel through an operation of the fuel cell system based on an ignition off command for the vehicle being input, and may control an ignition off of the vehicle based on the charging of the battery being completed.

According to an example embodiment, the processor may determine whether a long-term parking is planned after arriving at a preset destination, and may control an SOC ratio while the vehicle is in operating such that the SOC ratio is lower than a specified SOC reference ratio upon arrival at the destination when the long-term parking is planned as a result of the determining.

According to an example embodiment, the processor may measure an internal pressure of a hydrogen storage tank based on the ignition off command for the vehicle being input, and may operate the fuel cell system based on the measured internal pressure being greater than or equal to a preset reference pressure.

According to an example embodiment, the processor may compare an SOF (State Of Fuel) ratio of the hydrogen storage tank with a specified SOF reference ratio based on the measured internal pressure being less than the preset reference pressure, may wait for a preset period of time after the ignition off of the vehicle based on the comparison result, and may wake up a controller after the waiting for the preset period of time, and the fuel cell system may be operated by the woken-up controller.

According to an example embodiment, the processor may wait for a first time after the ignition off of the vehicle based on the SOF ratio being greater than or equal to the SOF reference ratio, and may wait for a second time after the ignition off of the vehicle based on the SOF ratio being less than the SOF reference ratio, and the first time may be set to be longer than the second time, and the first time may be set to an arbitrary value within 48 hours.

According to an example embodiment, the processor may monitor a change in the internal pressure of the hydrogen storage tank for the second time based on the SOF ratio being less than the SOF reference ratio, and may wake up the controller at a time before the internal pressure reaches a preset BOV (Boil-Off Valve) operating pressure.

According to an example embodiment, based on the measured internal pressure being less than the preset reference pressure and the SOF ratio being greater than or equal to the SOF reference ratio, the processor may operate an output of the fuel cell system with an output limited to a preset ratio of a maximum output or less.

According to an example embodiment, based on the measured internal pressure being less than the preset reference pressure and the SOF ratio being less than the SOF reference ratio, the processor may operate an output of the fuel cell system at a maximum output.

According to an example embodiment, the SOF reference ratio may be set to a (e.g., any) value less than 30% or 40%.

According to an example embodiment, the SOC reference ratio may be set to a (e.g., arbitrary) value of 40% or less based on at least one of a normal operating condition of the vehicle and/or an allowable life condition of the battery.

### BRIEF DESCRIPTION OF THE DRAWINGS

The above and other objects, features and advantages of the present disclosure will be provided from the following detailed description taken in conjunction with the accompanying drawings:

FIG. 1 is a phase diagram of liquid hydrogen used in a fuel cell system, according to an example embodiment of the present disclosure;

FIG. 2 is a diagram of a change in a mass of gaseous hydrogen present inside a liquid hydrogen container over time when heat is immersed in the liquid hydrogen container;

FIG. 3 is a diagram for a change in hold time depending on a wake-up timing of a fuel cell system after ignition off and parking, according to an example embodiment of the present disclosure;

FIG. 4 is a diagram of a change in pressure inside a liquid hydrogen container over time when heat is immersed in the liquid hydrogen container;

FIG. 5 is a diagram of a change in hold time depending on a wake-up time by an SOF ratio when heat is immersed in a liquid hydrogen container;

FIG. 6 is a flowchart for a fuel cell system control method for increasing a hold time, according to an example embodiment of the present disclosure;

FIG. 7 is a flowchart for describing a fuel cell system control method for increasing a hold time, according to another example embodiment of the present disclosure;

FIGS. 8 and 9 are flowcharts for describing a fuel cell system control method for increasing a hold time, according to another example embodiment of the present disclosure;

FIG. 10 is a diagram of a configuration of a hydrogen vehicle, according to an example embodiment of the present disclosure;

FIG. 11 is a diagram of a configuration of a hydrogen vehicle, according to another example embodiment of the present disclosure; and

FIG. 12 is a diagram of a computing apparatus, according to an example embodiment of the present disclosure.

### DETAILED DESCRIPTION

Hereinafter, some embodiments of the present disclosure will be described in detail with reference to the accompanying drawings. In the drawings, the same reference numerals will be used throughout to designate the same or equivalent elements. Further, in describing the embodiment of the present disclosure, a detailed description of the related known configuration or function may be omitted.

In describing the components of the example embodiments according to the present disclosure, terms such as first, second, A, B, (a), (b), and the like may be used. These terms are intended to distinguish the components from other components, and the terms do not limit the nature, order or sequence of the components. Unless otherwise defined, terms including technical and scientific terms used herein have the same meaning as commonly understood by one of ordinary skill in the art to which this disclosure belongs. Terms, such as those provided in commonly used dictionaries, should be interpreted as having a meaning that is consistent with their meaning in the context of the relevant art and may not be interpreted in an idealized or overly formal sense unless expressly so provided herein.

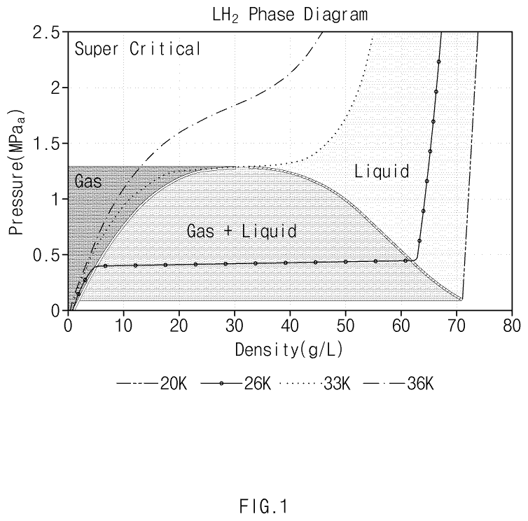

Hereinafter, various embodiments of the present disclosure will be described in detail with reference to FIGS. 1 to 12. FIG. 1 is a phase diagram of liquid hydrogen used in a fuel cell system, according to an example embodiment of the present disclosure.

Liquid hydrogen, unlike general fluids such as water, has the characteristic that its density changes (e.g., greatly) depending on the temperature.

As illustrated in FIG. 1, a phase diagram (or a state diagram) of liquid hydrogen illustrates a state change of liquid hydrogen according to the internal pressure of a liquid hydrogen container.

When liquid hydrogen evaporates and the pressure inside the container increases, the saturation temperature of liquid hydrogen rises, which reduces the density of liquid hydrogen and causes the volume to expand. This again increases the pressure inside the container, generating a cascading effect, so the pressure inside the container may rise rapidly. In addition, when the pressure and temperature rise to (e.g., about) 33K and 13 bars or more, hydrogen reaches a supercritical state, and the hydrogen density inside the container becomes uniform in a gaseous state. Since the pressure drop is (e.g., relatively) lower in the supercritical state than when gas is consumed in a two-phase mixed state of high-density liquid and low-density gas, the hydrogen storage efficiency may be lowered. Therefore, maintaining the two-phase state of gas and liquid as much as possible is useful for increasing the hydrogen storage efficiency.

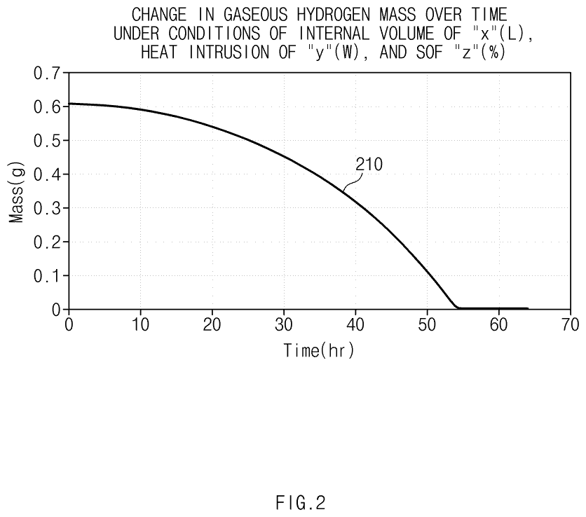

FIG. 2 illustrates a change in a mass of gaseous hydrogen present inside a liquid hydrogen container over time when heat is immersed in the liquid hydrogen container.

As shown in FIG. 2, liquid hydrogen expands due to external heat intrusion over time, and the boiling temperature of the liquid hydrogen increases, so that the mass of the gas decreases.

Referring to FIG. 2, when heat intrusion of “y” (Watt) occurs in a liquid hydrogen container with an internal volume of “x” (liter), the mass of gaseous hydrogen over time in an SOF (State of fuel) “z” (%) state gradually decreases as shown by the line labeled with reference numeral 210, and at a specific time, the gaseous hydrogen becomes a saturated state where there is no more mass change. SOF(State of Fuel) may include an amount of hydrogen charged in a hydrogen tank. This is because the temperature and pressure inside the container increase due to external heat intrusion, causing the liquid hydrogen to expand, and thus the gaseous hydrogen is re-liquefied.

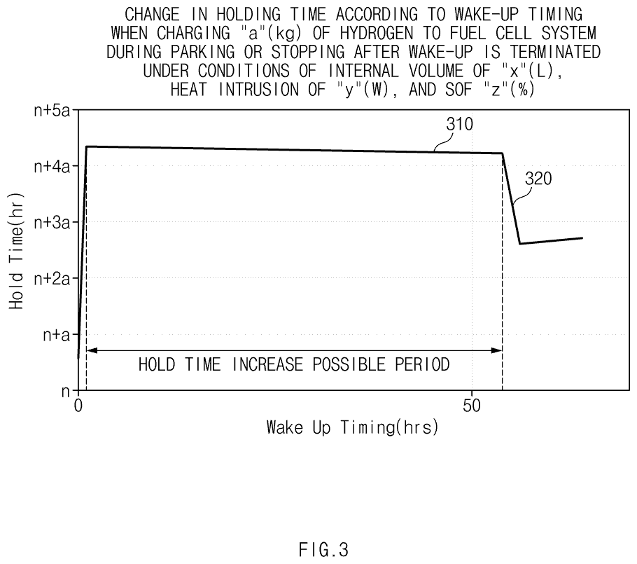

FIG. 3 is a diagram for describing a change in hold time depending on a wake-up timing of a fuel cell system after ignition off and parking, according to an example embodiment of the present disclosure.

In a hydrogen electric vehicle that uses liquid hydrogen as fuel, to increase the hydrogen storage period of the liquid hydrogen storage system, the fuel cell system may be driven to consume hydrogen to generate electricity while the vehicle is parked or stopped, during a wake-up of the vehicle, or when the wake-up is terminated. The electricity produced may be used to charge a vehicle battery. When the above-described method is applied, the liquid hydrogen may evaporate and expand due to external heat inflow into the liquid hydrogen container, and when the pressure inside the container increases, instead of discharging hydrogen through the boil-off valve, gaseous hydrogen is supplied to the fuel cell system to drive the stack, thereby producing electricity without discharging hydrogen to the outside, and thereby charging the vehicle battery, so that fuel loss may be minimized and the risk of fire (e.g., in advance) may be prevented.

FIG. 3 illustrates the change in a hold time according to the wake-up timing when “a” (kg) of hydrogen is charged to the fuel cell system in parking or stopping after the wake-up is terminated under the conditions of the internal volume “x” (L), the heat intrusion “y” (w), and the SOF “z” (%).

Reference numeral 310 illustrates that the hold time may be maximized when the vehicle is turned ON (woke up) within a specific time period after parking or stopping, and hydrogen is consumed by the fuel cell system. As illustrated in reference numeral 320, the hold time is illustrated to be drastically reduced when the wake-up is performed after a hold time increase possible period. The hold time increase possible period may be applied differently according to the conditions of the internal volume “x” (L), the heat intrusion “y” (w), and the SOF “z” (%).

For example, the fuel cell system control method according to the present disclosure may be implemented to charge the battery by driving the fuel cell system for a preset time after waking up at a preset period within the hold time increase possible period. The wake-up period and the fuel cell system driving period may be variably controlled based on at least one condition of the internal volume “x” (L), the pressure inside the container, the heat intrusion “y” (w), and the SOF “z” (%).

In a liquid hydrogen tank, when there is no external hydrogen supply under two-phase conditions, the liquid expands due to the heat inflow from the outside, and the pressure increase rate due to the liquid expansion is faster than the evaporation of the liquid, so the gaseous hydrogen is re-liquefied over time, and the amount of gaseous hydrogen decreases. Therefore, the gaseous hydrogen should be consumed (e.g., as quickly as possible) to decrease the pressure inside the liquid hydrogen container (e.g., quicker) when the same amount of hydrogen is consumed, thereby increasing the hold time.

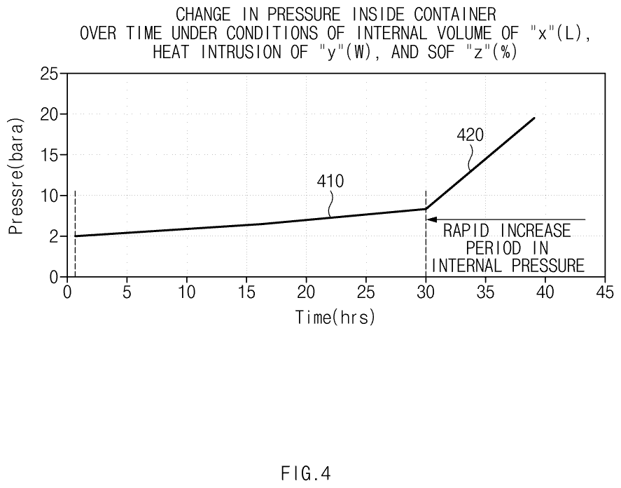

FIG. 4 illustrates a change in pressure inside a liquid hydrogen container over time when heat is immersed in the liquid hydrogen container.

Referring to FIG. 4, when heat intrusion of “y” (Watt) occurs in a liquid hydrogen container with the internal volume of “x” (liter), the pressure inside the container gradually increases over time in the SOF “z” (%) state until a specific time after the wake-up of the vehicle is terminated, as illustrated in reference numeral 410. After a specific time elapses after the wake-up of the vehicle is terminated, the pressure inside the container enters a rapid increase period as illustrated in reference numeral 420, and the pressure inside the container (e.g., substantially or explosively) increases. This is because the hydrogen inside the container is completely changed from gaseous hydrogen to liquid hydrogen or supercritical hydrogen, and here, the point in time when the pressure inside the container enters a rapid increase period may vary depending on the internal volume of “x” (L), the heat intrusion “y” (w), and the SOF “z” (%).

Hereinafter, wake-up control logic for increasing the hold time according to the present disclosure is provided.

When the vehicle is in an ignition off state, the pressure inside the container is measured, and when the measured internal pressure is 50% or more of the preset BOV (Boil-Off Valve) operating pressure, the fuel cell system may be operated (e.g., immediately) after the ignition off to prevent early pressure increase due to liquid expansion.

When the measured pressure inside the container is less than 50% of the BOV operating pressure when the vehicle is in the ignition off state, the fuel cell system may be controlled to operate for a second time after the first time elapses after the wake-up. In this embodiment, the output of the fuel cell system may be limited to operate below a specific percentage of the total output (or maximum output), for example, 80%. In this embodiment, the output limitation is applied to increase the hold time, more than the normal operating pressure, by controlling the hydrogen consumption of the fuel cell system lower than the normal state so that hydrogen may be consumed even at a lower pressure.

For example, the first time may be determined as a (e.g., any) time within 48 hours after 8 hours, and the second time may be determined as a time within 1 hour.

For example, the start-up time and the operation duration of the fuel cell system may be implemented to be dynamically determined based on the measured container pressure when the vehicle is in the ignition off state. In another example, the start-up time and the operation duration may be dynamically determined further based on at least one of the internal volume “x” (L), the heat intrusion “y” (w), and/or the SOF “z” (%).

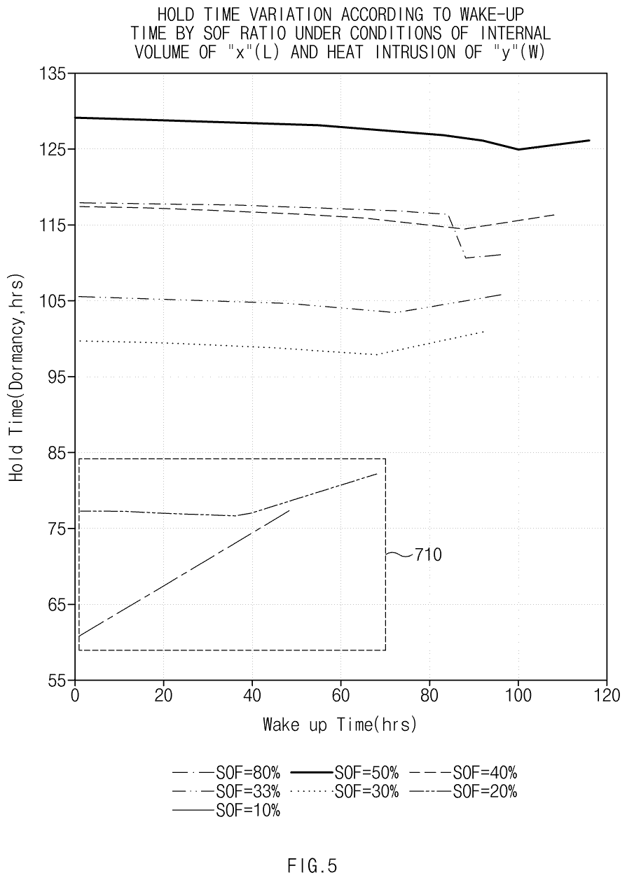

FIG. 5 illustrates a change in hold time depending on a wake-up time by an SOF ratio when heat is immersed in a liquid hydrogen container.

In FIG. 5, the hold time according to the wake-up time illustrates different patterns depending on the SOF ratio.

As illustrated by reference numeral 510, when the SOF ratio is less than a specific ratio, the hold time illustrates a pattern in which it increases in proportion to the wake-up time.

The fuel cell system control method for increasing the hold time according to the example embodiment of the present disclosure may be implemented to operate the fuel cell system to consume hydrogen when the SOF ratio measured during parking or stopping after the ignition off is less than a preset SOF reference ratio.

In this embodiment, the reference ratio may be set to the SOF boundary ratio where the composition of hydrogen inside the container is primarily (e.g., dominated) by a gas phase rather than a liquid phase. In an example embodiment, the SOF reference ratio may be (e.g., variably) set depending on the pressure inside the container. For example, the SOF reference ratio may be set to 40% or less, such as a (e.g., any) value between 34% to 36% or less.

When the pressure of the container is high, consuming hydrogen may increase the efficiency of a hydrogen storage period more than storing hydrogen in two phases. This is because, when more hydrogen is stored in the liquid hydrogen container in the form of gas (cryogenic vapor), operation in the gas phase has the primary (e.g., dominant) characteristic, and the smaller the amount of liquid hydrogen stored, consuming hydrogen (e.g., immediately) before the BOV starts increases the hold time than consuming hydrogen early after the wake-up to maintain two phases—that is, delaying the pressure increase as much as possible.

The fuel cell system control method for increasing the hold time according to an example embodiment of the present disclosure may be implemented to operate the fuel cell system at the point when the container pressure reaches 90% of the BOV operating pressure, when the container pressure is 50% or less of the BOV operating pressure, and/or the SOF ratio is less than a predetermined reference ratio, for example, an arbitrary value among 30 to 40% when the vehicle is in the ignition off state. In this embodiment, unlike the control logic described in FIG. 5, the fuel cell system may be controlled to operate at the maximum output without performing a separate output restriction.

In the above-described embodiments, when the fuel cell system is variably operated according to the liquid hydrogen charging amount (e.g., SOF ratio) and the container pressure to charge the battery, when the actual amount of hydrogen consumed for battery charging is small, it may be challenging to obtain a sufficient effect for increasing the hold time even if the fuel cell system is operated because the pressure drop in the container is small.

To address this challenge, the SOC (State of Charge) may be (e.g., forcibly) lowered as much as possible by discharging the battery when the vehicle is in the ignition off, but this may lower the battery usage efficiency and may reduce the fuel efficiency of the vehicle. SOC (state of charge) may include an amount of charge in the battery. In addition, when the driver arrives at the destination, parks or stops the vehicle for a period of time (e.g., a while), and then starts again, it may be unnecessary to apply the above-described hold time increasing logic.

According to another embodiment of the present disclosure, a fuel cell system control method for increasing hold time may perform SOC ratio control at a time when a preset remaining time remains from the expected arrival time of the destination or a preset remaining distance remains to the destination based on navigation destination setting information, so that the SOC ratio upon arrival at the destination may be controlled to be lower than a preset SOC reference ratio. In this embodiment, the remaining time or remaining distance for determining the start time of the SOC ratio control may be (e.g., variably) determined based on the expected average driving speed, expected power consumption, etc. to the destination. The SOC reference ratio according to the embodiment may be set to the lowest SOF possible under conditions that have little effect on the driving of the vehicle. For example, the SOC reference ratio may be set to 40%, such as the SOC reference ratio may be set to 20% or less depending on the allowable conditions of the battery life. Generally, if the SOC reference ratio is set too low, the battery life may be reduced. Therefore, the SOC reference ratio may be set by considering the trade-off between increasing the hold time and the battery life. For example, the SOC reference ratio may be set to an arbitrary value of 40% or less based on at least one of the normal operating conditions of the vehicle and/or the allowable conditions of the battery life.

For example, the fuel cell system control method for increasing the hold time according to the present disclosure may allow the driver to determine whether long-term parking is planned after arriving at the destination through a navigation pop-up window when setting a navigation destination. When the result of the determination indicates that long-term parking is planned, the SOC ratio control may be performed at a preset time before the expected arrival time of the destination or at a time when a preset remaining distance remains to the destination, so that the SOC ratio upon arrival at the destination may be controlled to be less than the preset SOC reference ratio.

The fuel cell system control method for increasing the hold time described herein may be (e.g., equally) applied to a hybrid vehicle that uses a hydrogen engine/battery instead of a fuel cell system/battery.

The above-described fuel cell system control method for increasing the hold time may be (e.g., equally) applied to a vehicle using a fuel storage system that overcomes the change in pressure inside the container due to temperature by using a PRV (Pressure Relief Valve), such as a vehicle using a cryo-compressed hydrogen storage system or an LNG(Liquefied Natural Gas) tank as a fuel storage source.

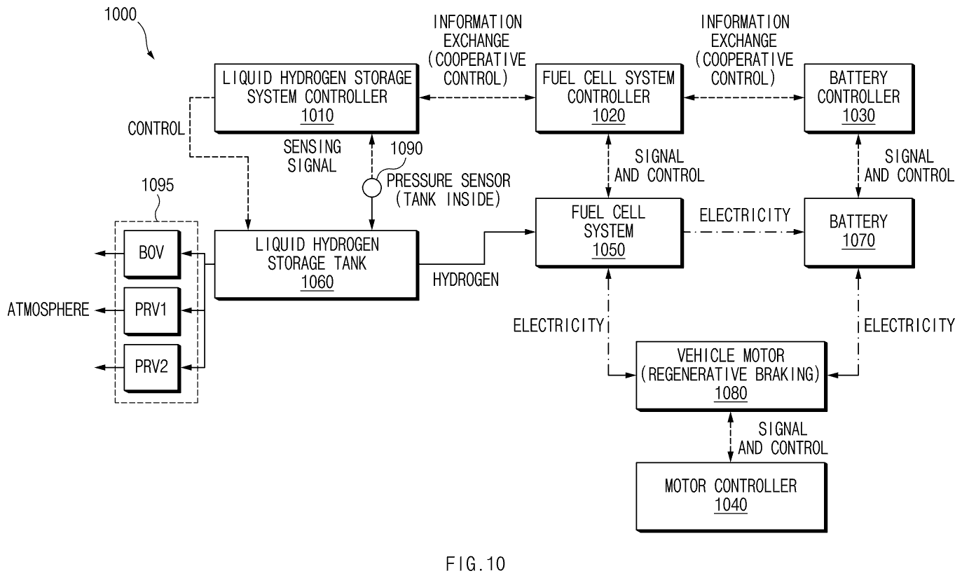

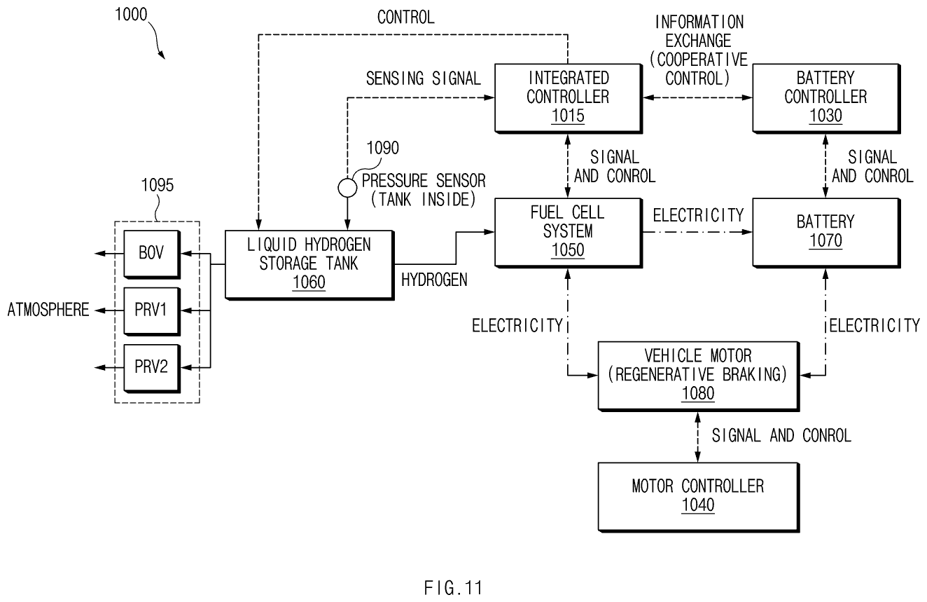

Hereinafter, the fuel cell system control methods for increasing the hold time of a hydrogen fuel stored in a liquid hydrogen storage tank are provided. The methods may be applied to a hydrogen vehicle equipped with a hydrogen fuel tank, and may be performed by at least one controller and an AVN (Audio Video Navigation) system mounted on the vehicle. For example, the controller may include at least one of a liquid hydrogen storage system controller 1010, a fuel cell system controller 1020, a battery controller 1030, and/or a motor controller 1040, as illustrated in FIG. 10 described below. For example, the liquid hydrogen storage system controller 1010 and the fuel cell system controller 1020 may be implemented as a single integrated controller 1015, as illustrated in FIG. 11. In the following description, a fuel cell system control method for increasing the hold time will be described as an example performed by a hydrogen vehicle.

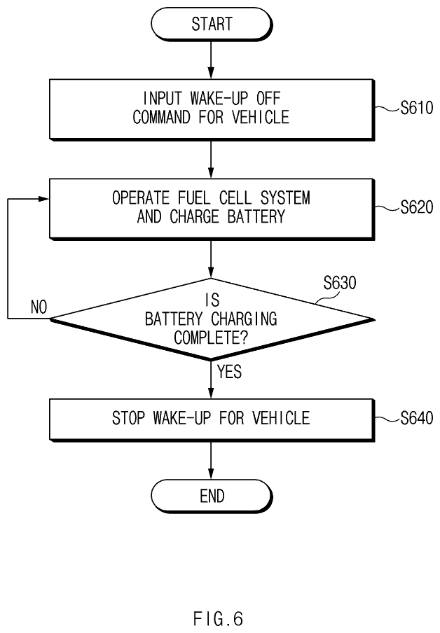

FIG. 6 is a flowchart for a fuel cell system control method for increasing a hold time, according to an example embodiment of the present disclosure.

Referring to FIG. 6, when an ignition off command for the vehicle is input, the hydrogen vehicle may operate the fuel cell system to start charging the battery (S610 and S620).

When the battery charging is completed (S630), the hydrogen vehicle may stop the wake-up for the vehicle (S640).

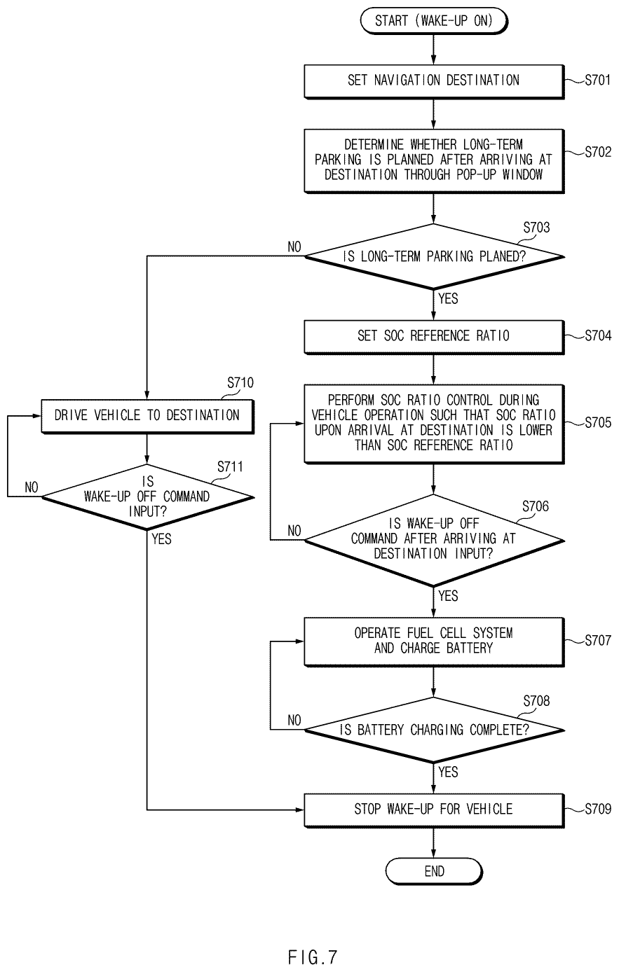

FIG. 7 is a flowchart for describing a fuel cell system control method for increasing a hold time, according to another example embodiment of the present disclosure.

Referring to FIG. 7, when a navigation destination is set, the hydrogen vehicle may generate a pop-up window to determine whether long-term parking is planned after arriving at the destination and may display the pop-up window on the navigation screen (S701 and S702).

As a result of the determination, when the long-term parking is planned, the hydrogen vehicle may set the SOC reference ratio and may perform the SOC ratio control during the vehicle operation such that the SOC ratio upon arrival at the destination is lower than the SOC reference ratio (S703 to S705). For example, the SOC reference ratio may be set to a (e.g., any) value lower than 40% based on at least one of the normal operating conditions of the vehicle and/or the allowable life conditions of the battery.

When an ignition off command is input after arriving at the destination, the hydrogen vehicle may operate the fuel cell system to charge the battery (S706 and S707).

When the battery charging is complete, the hydrogen vehicle may stop the wake-up for the vehicle (S708 and S709).

As a result of the determination in S703, when there is no plan to park long-term after arriving at the destination, the hydrogen vehicle may terminate the wake-up for the vehicle when the ignition off command is input after driving the vehicle to the destination (S710, S711, and S709).

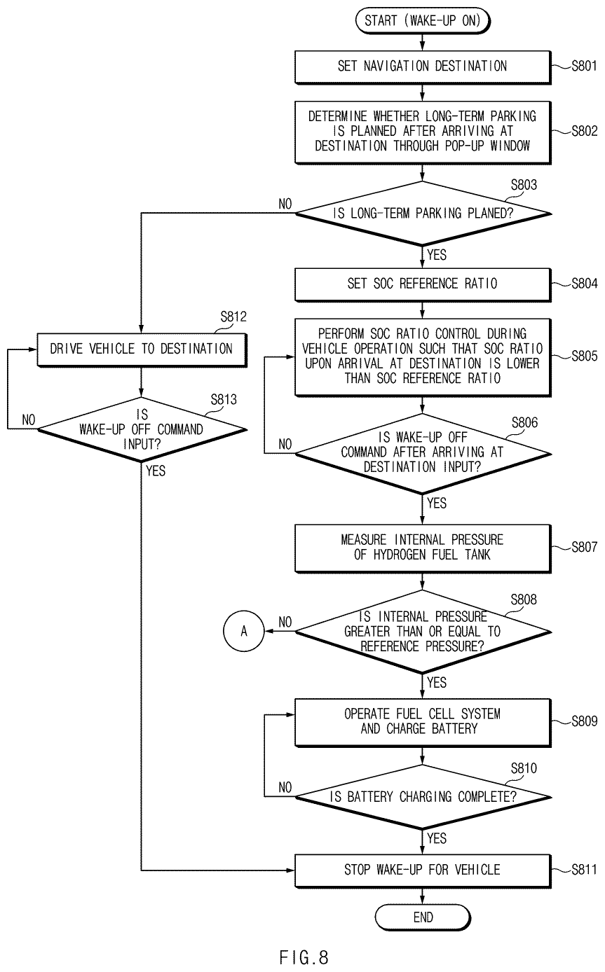

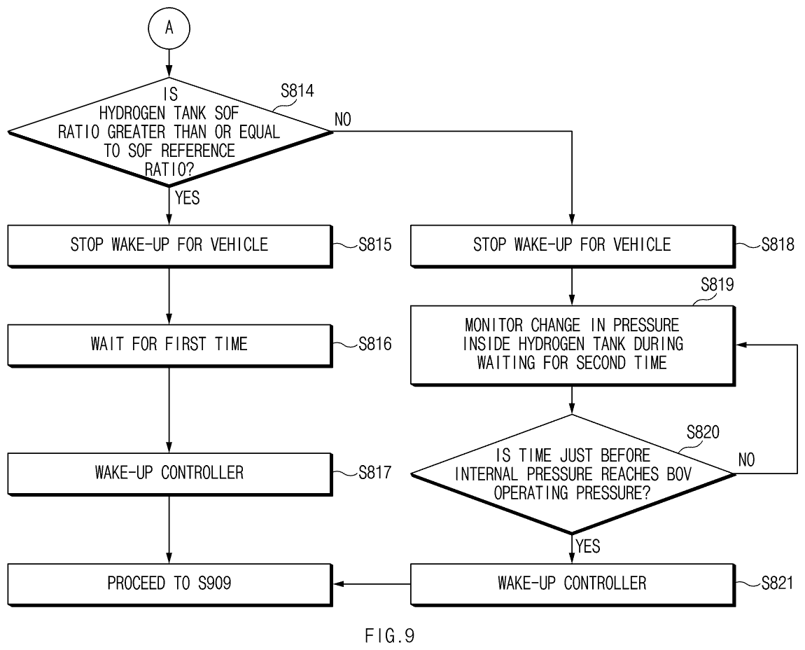

FIGS. 8 and 9 are flowcharts for a fuel cell system control method for increasing a hold time, according to another example embodiment of the present disclosure.

Referring to FIG. 8, when a navigation destination is set, the hydrogen vehicle may generate a pop-up window to determine whether long-term parking is planned after arriving at the destination and may display the pop-up window on the navigation screen (S801 and S802).

As a result of the determination, when the long-term parking is planned, the hydrogen vehicle may set the SOC reference ratio and may perform the SOC ratio control during the vehicle operation such that the SOC ratio upon arrival at the destination is lower than the SOC reference ratio (S803 to S805). For example, the SOC reference ratio may be set to a (e.g., any) value lower than 40% based on at least one of the normal operating conditions of the vehicle and/or the allowable life conditions of the battery.

When the ignition off command is input after arriving at the destination, the hydrogen vehicle may measure the internal pressure of the hydrogen fuel tank (S806 and S807).

The hydrogen vehicle may compare the measured internal pressure with a preset reference pressure (S808).

When the internal pressure is greater than or equal to the reference pressure as a result of the comparison, the hydrogen vehicle may start charging the battery by operating the fuel cell system (S809).

The hydrogen vehicle may terminate the wake-up for the vehicle when the battery charging is completed (S810).

As a result of the determination in S803, when there is no plan to park long-term after arriving at the destination, the hydrogen vehicle may terminate the wake-up for the vehicle when the ignition off command is input after driving the vehicle to the destination (S812, S813, and S811).

When the internal pressure is less than the reference pressure in S808, the steps in FIG. 9 may be performed.

Referring to FIG. 9, when the internal pressure is less than the reference pressure in S808, the hydrogen vehicle may compare the hydrogen tank SOF ratio with the preset SOF reference ratio (S814). In an example embodiment, the SOF reference ratio may be set to any value between 30% and 40%.

As a result of the comparison, when the hydrogen tank SOF ratio is greater than the SOF reference ratio, the hydrogen vehicle may stop the wake-up for the vehicle, may wait for a first time, and then may wake-up the corresponding controller (S815 to S817). When the corresponding controller wakes up, the hydrogen vehicle may enter S809 of FIG. 8 and may start charging the battery by operating the fuel cell system.

As a result of the comparison in S814, when the hydrogen tank SOF ratio is less than the SOF reference ratio, the hydrogen vehicle may monitor the change in the pressure inside the hydrogen tank while (e.g., during) waiting for a second time after the vehicle is in the ignition off (S818 and S819). In an example embodiment, the first time may be set longer than the second time. For example, the first time may be set to an arbitrary value within 48 hours and may be dynamically determined based on the current hydrogen tank sof ratio.

The hydrogen vehicle may wake-up the corresponding controller when the internal pressure reaches a specific ratio of the preset BOV operating pressure (S820 and S821). When the corresponding controller wakes up, the hydrogen vehicle may enter S809 of FIG. 8 and may start charging the battery by operating the fuel cell system. For example, the corresponding controller may be implemented to wake-up when the internal pressure reaches 90% of the BOV operating pressure, such as a (e.g., any) value between 85% and 95% (e.g., according to the design).

FIG. 10 provides a a configuration of a hydrogen vehicle, according to an example embodiment of the present disclosure.

Referring to FIG. 10, a hydrogen vehicle 1000 may be configured to include at least one of the liquid hydrogen storage system controller 1010, the fuel cell system controller 1020, the battery controller 1030, the motor controller 1040, a fuel cell system 1050, a liquid hydrogen storage tank 1060, a battery 1070, a vehicle motor 1080, a pressure sensor 1090, and/or an exhaust valve 1095. The hydrogen vehicle 1000 according to the example embodiment may further include a navigation system, for example, an AVN (Audio Video Navigation) system.

Electricity generated by driving the fuel cell system 1050 may be used to charge the battery 1070 and/or to drive the vehicle motor 1080.

The motor controller 1040 may monitor the status of the vehicle motor 1080 and may control the operation of the vehicle motor 1080 according to an acceleration command or a braking command.

The fuel cell system controller 1020 may perform cooperative control by exchanging information with the liquid hydrogen storage system controller 1010 and the battery controller 1030.

The fuel cell system controller 1020 may receive a sensing signal from the fuel cell system 1050 and may control the operation of the fuel cell system 1050 based on the received sensing signal. In this embodiment, the sensing signal may include, but is not limited to, the output voltage and the output current of the fuel cell system, the internal temperature, the fuel and air supply amounts, etc.

The fuel cell system controller 1020 may control the fuel and air supply amounts in a stack according to the (e.g., required) power amount to drive and control the fuel cell system.

The battery controller 1030 may receive the sensing signal of the battery 1070 to control the charging/discharging of the battery 1070 and may diagnose whether the battery is abnormal.

The liquid hydrogen storage system controller 1010 may collect status information of the liquid hydrogen storage tank 1060 and provide the status information to the fuel cell system controller 1020. In this embodiment, the status information may include measurement information such as pressure/temperature inside the tank, and may also include information on the SOF ratio.

The pressure sensor 1090 may measure an internal pressure of the liquid hydrogen storage tank 1060 and provide the internal pressure to the liquid hydrogen storage system controller 1010.

The liquid hydrogen storage system controller 1010 may monitor the internal pressure and temperature of the liquid hydrogen storage tank 1060, and when the internal pressure approaches the BOV operating pressure or the internal temperature exceeds a preset threshold, may control to open at least one of the BOV and/or the PRV such that the hydrogen in the tank is discharged into the atmosphere.

The fuel cell system controller 1020 according to the example embodiment of the present disclosure may operate the fuel cell system 1050 based on the internal pressure of the liquid hydrogen storage tank 1060 to charge the battery 1070 when the ignition off command is input after driving, thereby increasing the hold time of the hydrogen fuel in the liquid hydrogen storage tank 1060.

According to another example embodiment of the present disclosure, the fuel cell system controller 1020 may operate the fuel cell system 1050 based on the internal pressure and the SOF ratio of the liquid hydrogen storage tank 1060 when the ignition off command is input after driving, thereby charging the battery 1070, and thereby increasing the hold time of the hydrogen fuel in the liquid hydrogen storage tank 1060.

According to another example embodiment of the present disclosure, the fuel cell system controller 1020 may obtain driving information to the destination and information on whether long-term parking is planned after arriving at the destination by linking with a navigation system, and when long-term parking is planned after arriving at the destination, may perform SOC ratio control such that the SOC ratio before arriving at the destination reaches the preset SOC reference ratio. The present disclosure is useful in that it may maximize the efficiency of increasing the hold time when the fuel cell system 1050 is operated by maintaining the target SOC ratio when the ignition off command is input after driving through the SOC ratio control.

The fuel cell system controller 1020 according to another example embodiment of the present disclosure is useful in that it may maximize the efficiency of increasing the hold time when the fuel cell system 1050 is operated by variably controlling the operating time of the fuel cell system 1050 according to the SOF ratio measured after parking.

The fuel cell system controller 1020 according to another example embodiment of the present disclosure may prevent hydrogen gas from being discharged into the atmosphere in advance by consuming hydrogen fuel through the operation of the fuel cell system 1050 before the internal pressure of the liquid hydrogen storage tank 1060 reaches the BOV operating pressure during parking, thereby minimizing the risk of fire or explosion.

FIG. 11 provides a configuration of a hydrogen vehicle, according to another example embodiment of the present disclosure.

The liquid hydrogen storage system controller 1010 and the fuel cell system controller 1020 of FIG. 10 described above may be implemented as the single integrated controller 1015, as illustrated in FIG. 11.

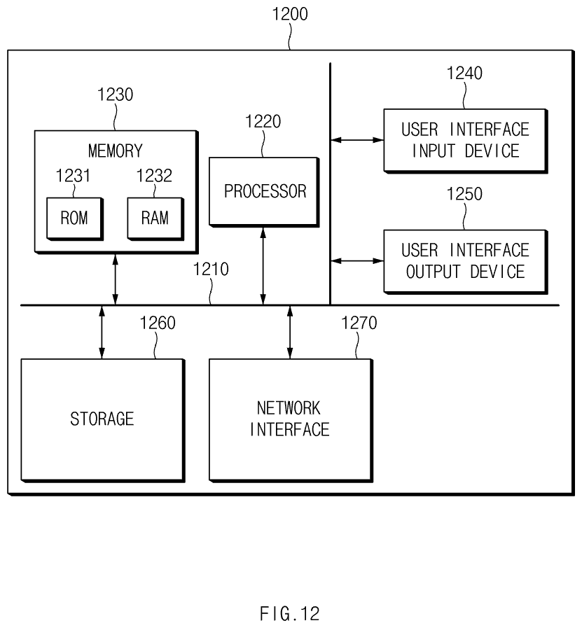

FIG. 12 illustrates a computing apparatus, according to an example embodiment of the present disclosure.

Referring to FIG. 12, a computing apparatus 1200 may be configured to include at least one of at least one processor 1220, a memory 1230, a user interface input device 1240, a user interface output device 1250, storage 1260, and/or a network interface 1270, which are connected with each other via a bus 1210.

The processor 1220 may be a central processing unit (CPU) or a semiconductor device that processes instructions stored in the memory 1230 and/or the storage 1260. Each of the memory 1330 and the storage 1260 may include various types of volatile or nonvolatile storage media. For example, the memory 1230 may include a read only memory (ROM) 1231 and a random access memory (RAM) 1232.

Accordingly, the method (procedure) or algorithm described in connection with the embodiments disclosed in the specification may be directly implemented with a hardware module, a software module, or a combination of the hardware module and the software module, which is executed by the processor 1220. The software module may reside on a storage medium (i.e., the memory 1230 and/or the storage 1260) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM). For example, the processor 1220 may form a part of the fuel cell vehicle system described above and may correspond to at least one of the controllers disclosed in FIG. 10 and/or FIG. 11.

The storage medium as an example may be coupled to the processor 1220. The processor 1220 may read out information from the storage medium and may write information into the storage medium. Alternatively, the storage medium may be integrated with the processor 1220. The processor and storage medium may be implemented with an application specific integrated circuit (ASIC). The ASIC may be provided in a controller within the vehicle. Alternatively, the processor 1220 and the storage medium may reside as the controller within the hydrogen vehicle or as a separate component within the hydrogen vehicle.

According to an example embodiment of the present disclosure, tthe control method for a hydrogen electric vehicle increases the hold time of the liquid hydrogen storage system and the apparatus therefor.

According to an example embodiment of the present disclosure, the fuel cell system battery control method and the apparatus therefor maximize the hold time of the liquid hydrogen storage system and minimize fuel loss due to evaporative hydrogen emission.

In addition, according to an example embodiment of the present disclosure, the fuel cell system battery control method and the apparatus therefor maximizes the hold time by variably controlling the wake-up time according to the pressure and the SOF (State of Fuel) of the liquid hydrogen storage system and minimizes fuel loss due to an evaporation of hydrogen under long-term parking conditions of the hydrogen fuel cell vehicle.

In addition, according to an example embodiment of the present disclosure, the hydrogen electric vehicle control method and the apparatus therefor minimizes fuel loss and prevents or minimizes the risk of fire by supplying gaseous hydrogen to the fuel cell system to drive the stack instead of discharging hydrogen through the boil-off valve when the liquid hydrogen evaporates and expands due to external heat inflow into the liquid hydrogen container and the pressure inside the container increases, thereby generating electricity without discharging hydrogen to the outside and charging the battery.

In addition to this, various effects identified directly or indirectly through this specification may be provided.

The above description is merely illustrative of the technical idea of the present disclosure, and those of ordinary skill in the art to which the present disclosure pertains will be able to make various modifications and variations without departing from the essential characteristics of the present disclosure.

Therefore, embodiments of the present disclosure are not intended to limit the technical spirit of the present disclosure, but provided only for the illustrative purpose. The scope of protection of the present disclosure should be construed by the attached claims, and all equivalents thereof should be construed as being included within the scope of the present disclosure.

What is claimed is:

1. A method of controlling a hydrogen electric vehicle, the hydrogen electric vehicle is includes a hydrogen storage system and a fuel cell system, the method comprising:
charging a battery by consuming a hydrogen fuel by operating the fuel cell system, based on an input of an ignition off command for the vehicle ; and
controlling an ignition off of the vehicle based on completion of the charging of the battery.

2. The method of claim 1, further comprising:
determining whether a long-term parking is planned after arriving at a preset destination; and
controlling a state of charge (SOC) ratio while the vehicle is operating, wherein the SOC ratio is lower than a specified SOC reference ratio upon arrival at the destination when the long-term parking is planned.

3. The method of claim 1, further comprising:
measuring an internal pressure of a hydrogen storage tank based on the input of the ignition off command for the vehicle, and operating the fuel cell system based on when the measured internal pressure is greater than or equal to a preset reference pressure.

4. The method of claim 3, further comprising:
comparing an SOF (State Of Fuel) ratio of the hydrogen storage tank with a SOF reference ratio based on when the measured internal pressure is less than the preset reference pressure;
waiting a preset period of time after the ignition off of the vehicle based on the comparison of the SOF ratio to the SOF reference ratio; and
waking up a controller after waiting the preset period of time, wherein the fuel cell system is operated by the controller.

5. The method of claim 4, further comprising:
waiting a first time after the ignition off of the vehicle based on when the SOF ratio is greater than or equal to the SOF reference ratio; and
waiting a second time after the ignition off of the vehicle based on when the SOF ratio is less than the SOF reference ratio, wherein the first time is set to be longer than the second time, and the first time is set to a value of less than or equal to 48 hours.

6. The method of claim 5, further comprising:
monitoring a change in the internal pressure of the hydrogen storage tank for the second time based on when the SOF ratio is less than the SOF reference ratio, and
wherein the controller is woken up at a time before the internal pressure reaches a preset BOV (Boil-Off Valve) operating pressure.

7. The method of claim 4, wherein based on when the measured internal pressure is less than the preset reference pressure and the SOF ratio is greater than or equal to the SOF reference ratio, an output of the fuel cell system is operated with an output limited to a preset ratio of a maximum output or less.

8. The method of claim 4, wherein based on when the measured internal pressure is less than the preset reference pressure and the SOF ratio is less than the SOF reference ratio, an output of the fuel cell system is operated at a maximum output.

9. The method of claim 4, wherein the SOF reference ratio is set to a value less than 30% or 40%.

10. The method of claim 2, wherein the SOC reference ratio is set to a value of 40% or less based on at least one of a normal operating condition of the vehicle or an allowable life condition of the battery.

11. A computing apparatus for controlling a hydrogen electric vehicle equipped with a hydrogen storage system and a fuel cell system, the computing apparatus comprising:
a memory storing computer-executable instructions; and
at least one processor configured to access the memory and execute the instructions, wherein the instructions comprise:
charging a battery by consuming a hydrogen fuel through an operation of the fuel cell system based on an input of an ignition off command for the vehicle, and
controlling an ignition off of the vehicle based on completion of the charging of the battery.

12. The computing apparatus of claim 11, wherein the instructions further comprise:
determining whether a long-term parking is planned after arriving at a preset destination, and
controlling an SOC ratio while the vehicle is operating, such that the SOC ratio is lower than a SOC reference ratio upon arrival at the destination, when the long-term parking is planned.

13. The computing apparatus of claim 11, wherein the instructions further comprise:
measuring an internal pressure of a hydrogen storage tank based on the input of the ignition off command for the vehicle, and
operating the fuel cell system based on when the measured internal pressure is greater than or equal to a preset reference pressure.

14. The computing apparatus of claim 13, wherein the instructions further comprise: comparing an SOF (State Of Fuel) ratio of the hydrogen storage tank with a SOF reference ratio based on when the measured internal pressure is less than the preset reference pressure,
waiting a preset period of time after the ignition off of the vehicle based on the comparison of the SOF ratio to the SOF reference ratio, and
waking a controller after waiting the preset period of time, wherein the fuel cell system is operated by the controller.

15. The computing apparatus of claim 14, wherein the instructions further comprise:
waiting a first time after the ignition off of the vehicle based on when the SOF ratio is greater than or equal to the SOF reference ratio, and
waiting a second time after the ignition off of the vehicle based on when the SOF ratio is less than the SOF reference ratio, wherein the first time is set to longer than the second time, and the first time is set to a value of less than or equal to 48 hours.

16. The computing apparatus of claim 15, wherein the instructions further comprise:
monitoring a change in the internal pressure of the hydrogen storage tank for the second time based on when the SOF ratio is less than the SOF reference ratio, and
waking up the controller at a time before the internal pressure reaches a preset BOV (Boil-Off Valve) operating pressure.

17. The computing apparatus of claim 14, wherein based on when the measured internal pressure is less than the preset reference pressure and the SOF ratio is greater than or equal to the SOF reference ratio, the instructions further comprise:
operating an output of the fuel cell system with an output limited to a preset ratio of a maximum output or less.

18. The computing apparatus of claim 14, wherein based on when the measured internal pressure is less than the preset reference pressure and the SOF ratio being less than the SOF reference ratio, the instructions further comprise:
operating an output of the fuel cell system at a maximum output.

19. The computing apparatus of claim 14, wherein the SOF reference ratio is set to a value less than 30% or 40%.

20. The computing apparatus of claim 12, wherein the SOC reference ratio is set to a value of 40% or less based on at least one of a normal operating condition of the vehicle or an allowable life condition of the battery.
